(19) United States
(12) Patent Application Publication
(10) Pub. No.: US 2018/0107665 A1
(43) Pub. Date: Apr. 19, 2018

(54) SYSTEMS AND METHODS FOR DETERMINING RECOMMENDATIONS FOR PAGES IN SOCIAL NETWORKING SYSTEMS

(71) Applicant: Facebook, Inc., Menlo Park, CA (US)

(72) Inventors: Danlei Yang, San Mateo, CA (US); Daniel Dinu, Sunnyvale, CA (US); Neal Suresh Vora, San Jose, CA (US)

(21) Appl. No.: 15/295,882

(22) Filed: Oct. 17, 2016

(51) Int. Cl. G06F 17/30; G06Q 50/00; G06N 99/00

(52) U.S. Cl. CPC G06F 17/3053; G06N 99/005; G06Q 50/01

(57) ABSTRACT

Systems, methods, and non-transitory computer-readable media according to certain aspects can obtain a goal associated with a page provided by a social networking system. Potential recommendations for the page can be determined based on a first machine learning model. The potential recommendations can be ranked based on a second machine learning model to identify a subset of recommendations relating to the goal.

### FIELD OF THE INVENTION

The present technology relates to the field of social networks. More particularly, the present technology relates to providing recommendations in social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be given the opportunity to interact with profiles or pages on the social networking system that are associated with other users or entities. The profiles and the pages can be dedicated locations on the social networking system to reflect the presence of the other users and entities on the social networking system. A user can interact with the profiles and the pages in a variety of manners. For example, a user can send a message to a page associated with a business or comment on posts on the page.

### SUMMARY

Various embodiments of the present disclosure can include systems, methods, and non-transitory computer readable media configured to obtain a goal associated with a page provided by a social networking system. Potential recommendations for the page can be determined based on a first machine learning model. The potential recommendations can be ranked based on a second machine learning model to identify a subset of recommendations relating to the goal.

In some embodiments, one or more recommendations of the identified subset of recommendations are provided for display in a user interface associated with the page.

In certain embodiments, access to a content item relating to a recommendation of the one or more recommendations is provided in the user interface associated with the page, wherein the content item relating to the recommendation provides instructions associated with performing the recommendation.

In an embodiment, the goal is associated with a metric that measures performance of the goal.

In some embodiments, the ranking the potential recommendations is based on a probability of each of the potential recommendations improving performance of the metric.

In certain embodiments, the first machine learning model is trained based on training data that includes information relating to a plurality of pages and recommendations provided to the plurality of pages.

In an embodiment, the second machine learning model is trained based on training data that includes information relating to one or more of: a plurality of pages, goals associated with the plurality of pages, metrics associated with the goals, recommendations provided to the plurality of pages, performance of the metrics, or administrators associated with the plurality of pages.

In some embodiments, the first machine learning model and the second machine learning are the same.

In certain embodiments, a first recommendation and a second recommendation in the identified subset of recommendations are related, and the first recommendation and the second recommendation are provided in a sequential order in time.

In an embodiment, the ranking the potential recommendations comprises determining whether the potential recommendations satisfy eligibility criteria associated with the page.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example recommendation determination module configured to determine recommendations for pages, according to an embodiment of the present disclosure.

FIG. 2 illustrates an example recommendation ranking module configured to rank recommendations for pages, according to an embodiment of the present disclosure.

FIG. 3A illustrates an example first user interface for providing recommendations for pages, according to an embodiment of the present disclosure.

FIG. 3B illustrates an example second user interface for providing recommendations for pages, according to an embodiment of the present disclosure.

FIG. 4 illustrates an example first method for determining recommendations for pages, according to an embodiment of the present disclosure.

FIG. 5 illustrates an example second method for determining recommendations for pages, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Determination of Recommendations for Pages in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a social networking system (e.g., a social networking service, a social network, etc.). The social networking system can allow the users, for example, to add connections, or post content items.

The social networking system may provide pages for various entities. For example, pages may be associated with companies, businesses, brands, products, artists, public figures, entertainment, individuals, and other types of entities. The pages can be dedicated locations on the social networking system to reflect the presence of the entities on the social networking system. The pages can publish content that is deemed relevant to the associated entities to promote interaction with the pages. Interaction with the pages can involve users visiting pages, accessing content published by the pages, sending messages to the pages, commenting on content on the pages, etc. Administrators associated with pages can manage the pages, review information associated with the pages, and take any necessary actions to maintain and enhance user interaction with the pages.

In many cases, conventional approaches specifically arising in the realm of computer technology may provide recommendations associated with websites or pages associated with entities. For example, conventional approaches can provide general recommendations to administrators associated with the websites or pages. The general recommendations can relate to, for example, actions that can be taken in connection with the websites or pages, features or functionalities available for the websites or pages, etc. However, conventional approaches may not provide customized recommendations tailored to particular websites or pages, for example, in connection with what administrators are trying to accomplish for entities.

An improved approach rooted in computer technology can overcome the foregoing and other disadvantages associated with conventional approaches specifically arising in the realm of computer technology. Based on computer technology, the disclosed technology can provide customized recommendations for a page based on one or more goals associated with the page. For example, the disclosed technology can determine potential recommendations for a page and rank the potential recommendations in view of one or more goals associated with the page. The disclosed technology can allow an administrator of a page to specify one or more goals associated with the page. Each goal can be associated with one or more metrics that can measure performance of a page with respect to the goal. Recommendations can be selected to improve metrics associated with goals. The disclosed technology can determine potential recommendations based on attributes associated with pages, attributes associated with administrators, etc. For example, potential recommendations can be selected based on similarity of pages. Potential recommendations for a page can be ranked in view of the goals and associated metrics. The disclosed technology can rank the potential recommendations based on attributes associated with pages, attributes associated with administrators, performance of similar pages, etc. One or more recommendations from the ranked recommendations can be provided to an administrator through a user interface. The disclosed technology can determine potential recommendations and rank the potential recommendations based on machine learning techniques. In this manner, the disclosed technology can provide recommendations that are customized for a page to help achieve goals set for the page. The customized recommendations can be selected based on metrics associated with the goals and performance of similar pages, and therefore can increase the probability of improving performance of the page in connection with the goals.

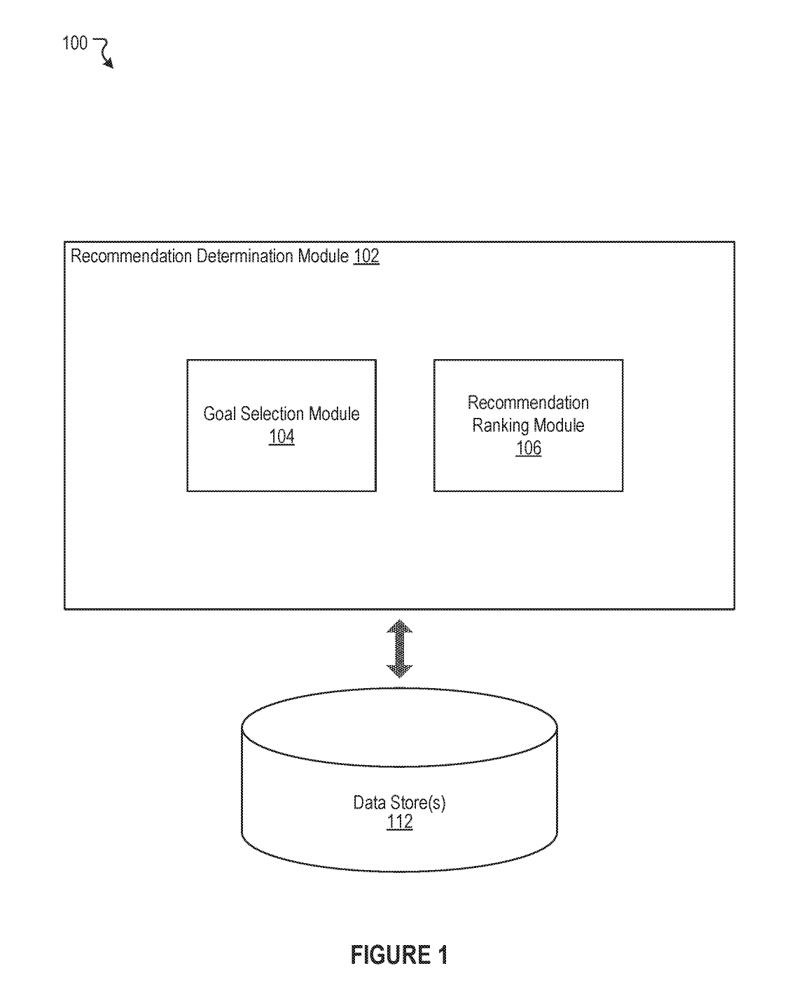

FIG. 1 illustrates an example system 100 including an example recommendation determination module 102 configured to determine recommendations for pages, according to an embodiment of the present disclosure. As shown in the example of FIG. 1, the recommendation determination module 102 can include a goal selection module 104 and a recommendation ranking module 106. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

The goal selection module 104 can obtain one or more goals associated with a page. In some embodiments, an administrator of a page can select from predefined goals. In some embodiments, an administrator can define goals. In other embodiments, a goal can be inferred from information or administrator activity associated with a page. Each goal can relate to one or more metrics. In one example, a goal associated with a page can be to increase sales, and metrics associated with increasing sales can be an ad click-through rate (CTR) for advertisements associated with the page and product clicks by users on products presented on the page. In another example, a goal associated with a page can be to raise awareness, and a metric associated with raising awareness can be reach. Reach can indicate a number of users reached by a post of page. Many variations are possible. An administrator can select or define a goal for a page through a user interface of the page.

The recommendation ranking module 106 can determine potential recommendations for a page and rank the potential recommendations based on a goal of the page. The recommendation ranking module 106 can initially determine potential recommendations for a page from a set of available recommendations or tips. The recommendation ranking module 106 can then rank the determined potential recommendations for the page based on the goal of the page. The recommendation ranking module 106 is discussed in greater detail herein.

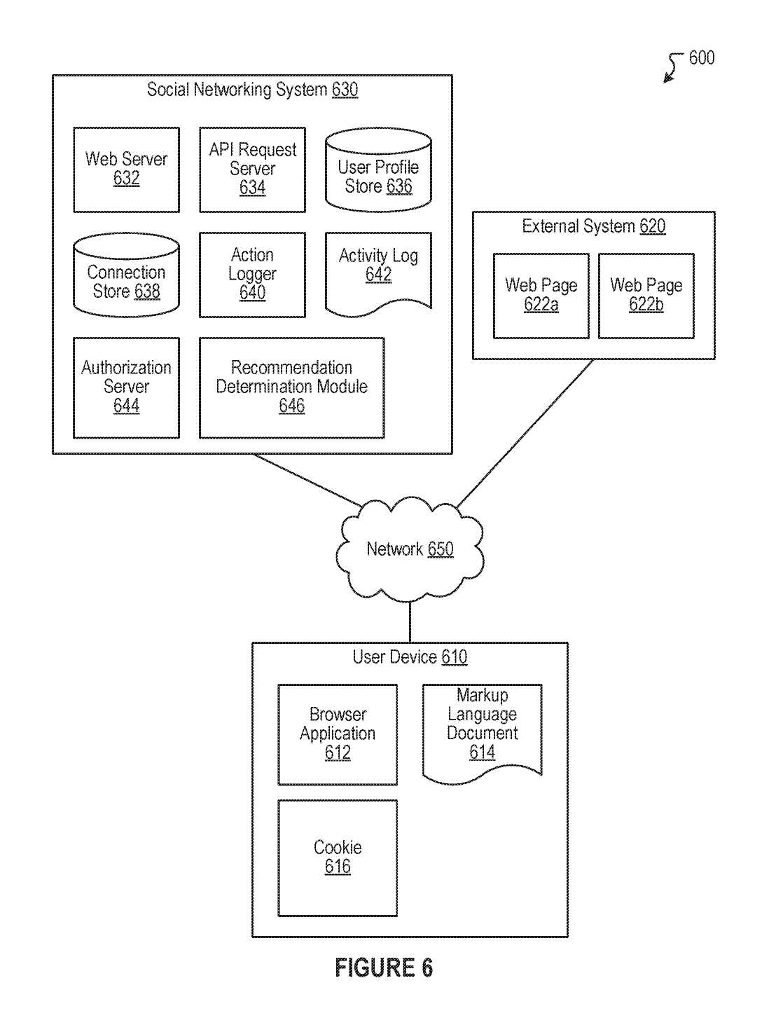

The recommendation determination module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the recommendation determination module 102 can be implemented, in part or in whole, as software running on one or more computing devices or systems, such as on a server computing system or a user (or client) computing system. For example, the recommendation determination module 102 or at least a portion thereof can be implemented as or within an application (e.g., app), a program, or an applet, etc., running on a user computing device or a client computing system, such as the user device 610 of FIG. 6. In another example, the recommendation determination module 102 or at least a portion thereof can be implemented using one or more computing devices or systems that include one or more servers, such as network servers or cloud servers. In some instances, the recommendation determination module 102 can, in part or in whole, be implemented within or configured to operate in conjunction with a social networking system (or service), such as the social networking system 630 of FIG. 6. It should be understood that there can be many variations or other possibilities.

The recommendation determination module 102 can be configured to communicate and/or operate with the at least one data store 112, as shown in the example system 100. The data store 112 can be configured to store and maintain various types of data. In some implementations, the data store 112 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user locations, user specified settings, content produced or posted by users, and various other types of user data. In some embodiments, the data store 112 can store information that is utilized by the recommendation determination module 102. For example, the data store 112 can store data relating to pages, goals for pages, metrics associated with goals, potential recommendations for pages, ranked recommendations for pages, machine learning models, performance of pages with respect to goals and/or metrics, and the like. It is contemplated that there can be many variations or other possibilities.

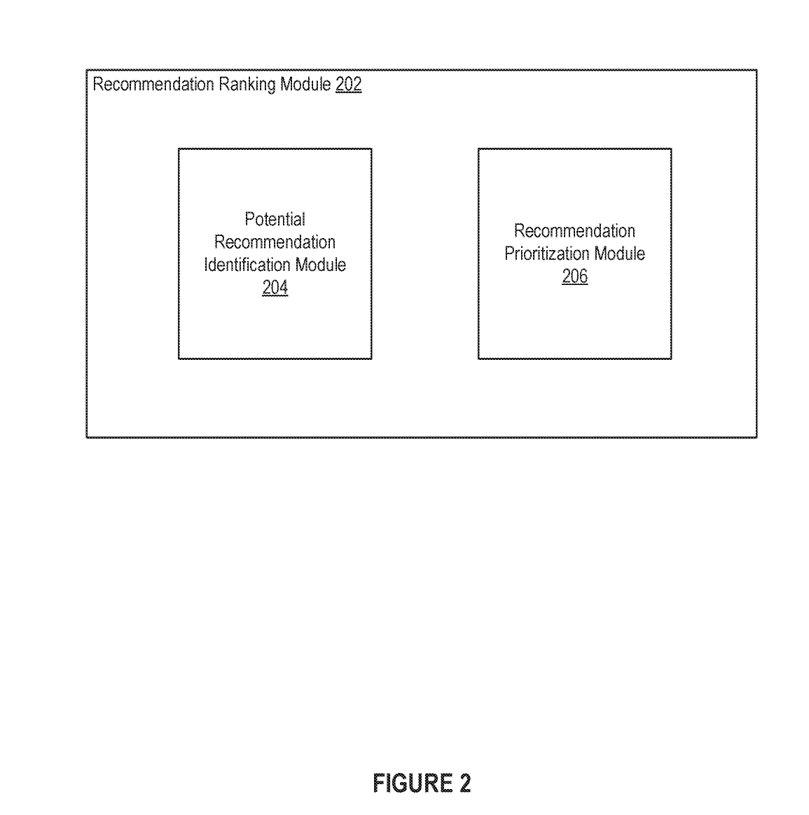

FIG. 2 illustrates an example recommendation ranking module 202 configured to rank recommendations for pages, according to an embodiment of the present disclosure. In some embodiments, the recommendation ranking module 106 of FIG. 1 can be implemented as the example recommendation ranking module 202. As shown in FIG. 2, the recommendation ranking module 202 can include a potential recommendation identification module 204 and a recommendation prioritization module 206.

The potential recommendation identification module 204 can identify potential recommendations from a set of available recommendations or tips. Available recommendations can include all possible recommendations that can be provided to an administrator of a page. For example, recommendations can provide information that can help an administrator manage or perform various functionalities associated with a page. Examples of recommendations can include responding to items (e.g., messages, comments, reviews, posts, etc.), responding to unread items, posting at a particular time, posting with frequency, optimizing by targeting a particular demographic, setting up a shop, refreshing content of products, retargeting users who have visited, etc. All examples herein are provided for illustrative purposes, and there can be many variations and other possibilities.

The potential recommendation identification module 204 can determine potential recommendations based on attributes associated with pages, attributes associated with administrators, etc. Attributes can be associated with pages, administrators, etc. For example, page-level attributes can include a category of a page, an age of a page, a location of a page, a level of user activity, a number of fans of a page, feature participation for a page, etc. Feature participation for a page can indicate how many features or functionalities associated with the page have been used, for example, by administrators of the page. Administrator-level attributes can include a stage of an administrator, capabilities of an administrator, feature participation by an administrator, etc. A stage of an administrator can indicate an experience level of an administrator (e.g., new, experienced, etc.). Capabilities of an administrator can include roles of an administrator, device information of an administrator, etc. Roles of an administrator can indicate which functionalities an administrator can access with respect to a page. For example, a full administrator can have access to all functionalities with respect to a page, whereas an administrator with an editor role can access all functionalities other than setting roles of other administrators. Examples of roles of an administrator can include a full administrator, an editor, a moderator, an advertiser, an analyst, etc. Capabilities of an administrator can also include device information for an administrator that relates to a computing device that is used by the administrator to interact with an associated page. For example, a device of an administrator may support certain functionalities, but not others. In such case, device information for the administrator can be considered in determining potential recommendations. In this way, an administrator can be provided with recommendations the administrator can actually can perform or complete. Similar to feature participation for a page, feature participation by an administrator can indicate how many features or functionalities have been used by the administrator. Feature participation by an administrator can provide a way of assessing or estimating a skill level associated with an administrator. For example, feature participation of an administrator across all pages with which the administrator is associated can be considered.

The potential recommendation identification module 204 can determine potential recommendations for a page based on a machine learning model. The potential recommendation identification module 204 can train a machine learning model based on training data that includes recommendations and pages to which the recommendations are provided. Various features can be used in training the machine learning model. For example, features can be selected from attributes discussed above, such as page-level attributes and administrator-level attributes. The potential recommendation identification module 204 can apply the trained machine learning model to determine potential recommendations for a page. Potential recommendations for a page can include recommendations that are provided to pages that are similar to the page. The machine learning model can be retrained based on new or updated training data. For example, if information about new recommendations or pages becomes available, the potential recommendation identification module 204 can train the machine learning model based on the information about new recommendations or pages. The potential recommendation identification module 204 can refine the machine learning model in order to achieve desired results, for example, by retraining the machine learning model, adjusting features included in the machine learning model, etc. In some cases, an administrator can provide feedback relating to a recommendation presented to the administrator. Feedback by administrators can be used to train or retrain the machine learning model for determining potential recommendations, for example, as a part of the training data.

The recommendation prioritization module 206 can rank potential recommendations for a page based on one or more goals associated with the page. In some embodiments, if more than one goal is selected for a page, the recommendation prioritization module 206 can rank the potential recommendations for each goal. In some embodiments, the recommendation prioritization module 206 can rank the potential recommendations for all goals at the same time. The recommendation prioritization module 206 can rank the potential recommendations for a page based on a machine learning model. In some embodiments, the potential recommendation identification module 204 and the recommendation prioritization module 206 can use the same machine learning model. For example, a machine learning model can be trained to determine potential recommendations for a page and rank the potential recommendations based on goals of the page.

The recommendation prioritization module 206 can train a machine learning model based on training data that includes recommendations that are provided to pages, goals or metrics associated with the pages, and performance of the pages with respect to the goals or metrics associated with the pages. Various features can be used in training the machine learning model. For example, features can be selected from page-level attributes, administrator-level attributes, performance-related attributes, etc. Performance-related attributes can indicate performance of metrics that are associated with goals of pages. For example, if a goal of a page is increasing sales and the metric associated with the goal is an ad CTR, a performance-related attribute in the training data can indicate performance of the ad CTR metric for the page. The machine learning model can be retrained based on new or updated training data. For example, if information about new recommendations, pages, or page performance becomes available, the recommendation prioritization module 206 can train the machine learning model based on the information about new recommendations, pages, or page performance. The recommendation prioritization module 206 can refine the machine learning model in order to achieve desired ranking results, for example, by retraining the machine learning model, adjusting features included in the machine learning model, etc. In some cases, an administrator can provide feedback relating to a recommendation presented to the administrator. Feedback by administrators can be used to train or retrain the machine learning model for ranking potential recommendations, for example, as a part of the training data.

The recommendation prioritization module 206 can apply the trained machine learning model to rank potential recommendations for a page. Potential recommendations for a page can be ranked to determine which recommendations are likely to help achieve a goal of a page. For example, potential recommendations for a page can be ranked to determine which recommendations are likely to improve a metric associated with a goal of the page. The trained machine learning model can output a score for a potential recommendation. Potential recommendations for a page can be ranked based on performance associated with recommendations shown to pages that are similar to the page. For example, recommendations for a dentist page in a suburban area and performance of the dentist page with respect to one or more goals can be relevant to another dentist page in another suburban area. As explained above, performance of a page with respect to one or more goals can be measured or indicated in terms of performance of one or more metrics associated with the goals. Similar recommendations can be provided for similar pages having similar goals. Prior to applying the trained machine learning model to rank potential recommendations, the recommendation prioritization module 206 can determine whether eligibility criteria relating to a particular recommendation is satisfied. Eligibility criteria can indicate one or more conditions that should be satisfied for a recommendation to be applicable for a page. For example, for the recommendation for adding a profile photo, the recommendation prioritization module 206 can check whether a page has a profile photo. If a page already has a profile photo, the recommendation for adding a profile photo is not included as a potential recommendation for the page and therefore not ranked. The recommendation prioritization module 206 can rank recommendations that satisfy eligibility criteria in the context of a particular page. The trained machine learning model can determine a score for each eligible recommendation for a page. The score for a potential recommendation can indicate or reflect expected performance of a metric associated with a goal of the page for the potential recommendation. In some embodiments, the score for a potential recommendation can indicate or reflect a probability of the potential recommendation improving performance of a metric associated with a goal of the page. Eligible recommendations can be ordered according to the scores, and top recommendations can be provided to an administrator.

The recommendation prioritization module 206 can present recommendations to an administrator based on various considerations. For example, a relationship between recommendations can be considered. In certain embodiments, recommendations can be presented in a sequence that optimizes achievement of goals associated with pages. Recommendations that are presented at a particular time can be selected to increase a probability of achieving goals of a page. In a similar way, recommendations that are presented over time can also be selected in a manner that can increase a probability of achieving goals of a page. For example, if it is observed that presenting a first recommendation prior to a second recommendation for a page with a particular goal can lead to a higher level of performance with respect to the goal, the first recommendation and the second recommendation can be presented in the same sequence to another page with similar attributes. In some cases, a sequence of recommendations can be determined to increase a probability of an administrator completing recommendations since the administrator actually completing the recommendations can help achieve goals of a page. Machine learning techniques can be used to determine sequences of recommendations. In some embodiments, machine learning techniques can include artificial neural networks, deep neural network, etc.

Determining and ranking recommendations have been described in connection with pages for illustrative purposes, and the present disclosure can apply to any type of items or applications associated with a social networking system, such as groups, applications associated with pages, etc. For example, recommendations can be determined and ranked for a group. Examples of recommendations for a group can include responding to posts in your group, setting up a group for all administrators, etc. In another example, recommendations can be determined and ranked for applications associated with pages, such as a chat application. Examples of recommendations for a chat application can include replying to messages, setting up an away indicator, etc.

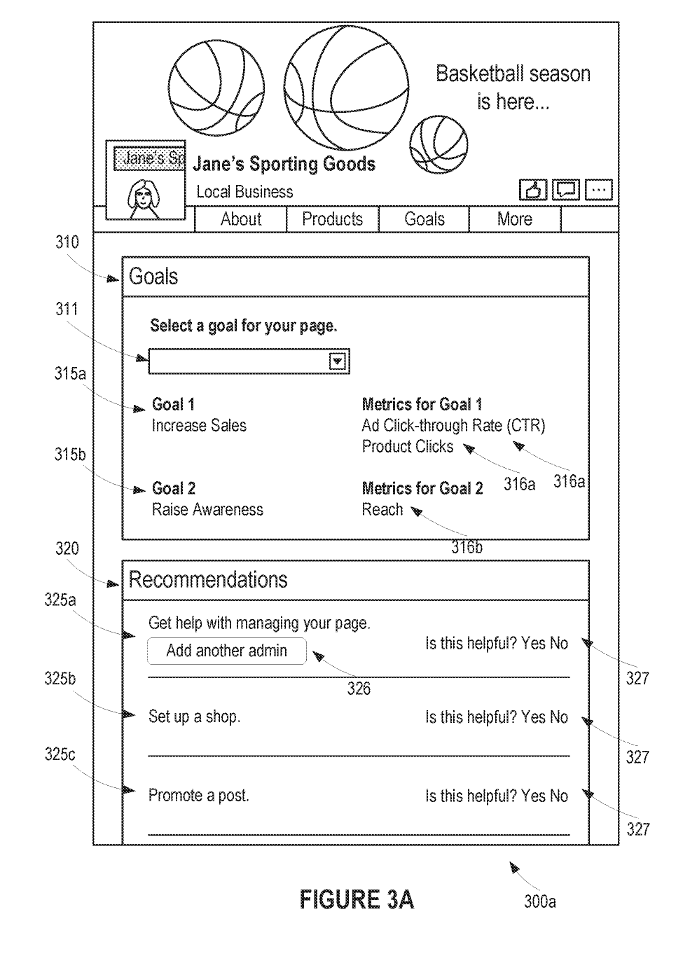

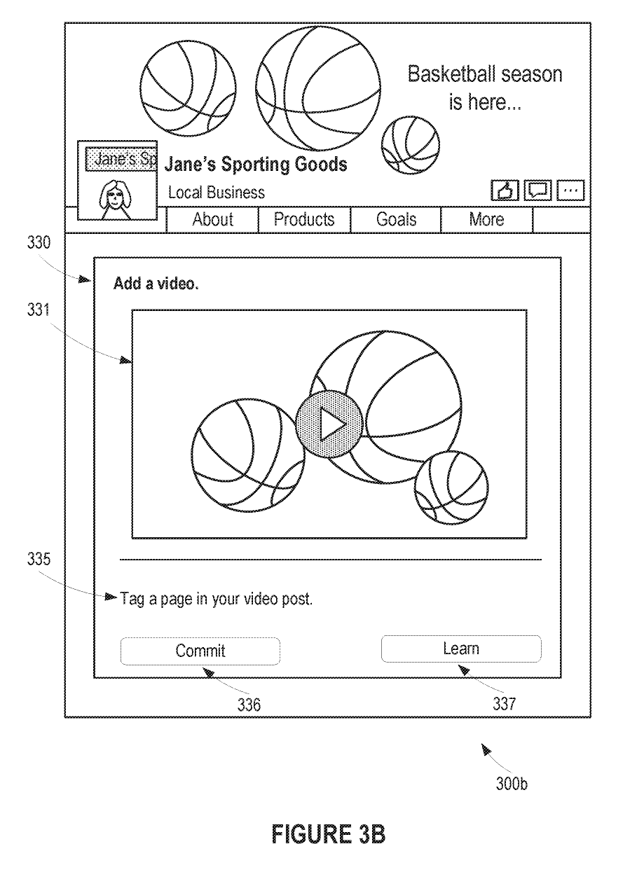

FIG. 3A illustrates an example first user interface 300a for providing recommendations for pages, according to an embodiment of the present disclosure. A section 310 can allow an administrator to select or define one or more goals associated with a page. The section 310 can include a dropdown menu 311 that allows the administrator to select one or more goals. The section 310 can also include a text field or text box (not shown) that allows the administrator to enter one or more goals. The section 310 can display one or more metrics associated with a goal such that the administrator can see which metrics could be measured in connection with the goal. In the example of FIG. 3A, the user interface 300a displays two goals 315a, 315b. For example, Goal 1 315a is “Increase sales,” and Goal 2 315b is “Raise awareness.” The user interface 300a also displays metrics 316a, 316b associated with the two goals 315a, 315b. For example, metrics associated with Goal 1 316a are “Ad click-through rate (CTR)” and “Product clicks.” A metric associated with Goal 2 316b is “Reach.”

A section 320 can display recommendations 325a, 325b, 325c that have been selected for the page based on the one or more goals for the page. The number of recommendations displayed at one time in the section 320 can be determined as appropriate. A recommendation can have an action button 326 associated with it. For example, a first recommendation 325a is “Get help with managing your page,” and an action button 326 associated with the first recommendation is “Add another admin.” An administrator can click on the action button 326 in order to access a feature for adding another administrator. The section 320 can include a mechanism for an administrator to provide feedback regarding recommendations. For example, the section 320 can display a question 327 “Is this helpful” next to a recommendation, and the administrator can click “Yes” or “No.” As explained above, feedback from administrators regarding recommendations can be used to train and retrain machine learning models.

A recommendation can be displayed for a specified period of time. Displaying the same recommendation for a long period of time may not be helpful to an administrator, and accordingly, a recommendation can have an associated time period for display. The recommendation can be displayed for the time period and, after the time period, removed from the section 320. In some embodiments, the recommendation can be provided again to the administrator at a subsequent time. Or the recommendation that has been provided can be excluded from being provided again at a subsequent time. All examples herein are provided for illustrative purposes, and there can be many variations and other possibilities.

FIG. 3B illustrates an example second user interface 300b for providing recommendations for pages, according to an embodiment of the present disclosure. In some embodiments, a recommendation can be presented to an administrator in a context in which the recommendation is applicable. For example, recommendations relating to rich content items (e.g., graphs, snippets, videos, photos, etc.) can be presented in proximity of the rich content items so that they are accessible in the context of the rich content items. A recommendation can be presented with related content such that if an administrator does not know how to perform a functionality suggested by the recommendation, the administrator can access the related content to learn how to perform the functionality.

The user interface 300b can include a section 330 for creating or adding a rich content item. In the example of FIG. 3B, the rich content item 331 is a video, and a recommendation 335 associated with a video is provided in the section 330. The recommendation 335 can be a recommendation selected based on a goal associated with a page. In the example of FIG. 3B, the recommendation 335 is “tag a page in your video post.” Two action buttons can be provided in connection with the recommendation 335. Selecting a commit action button 336 can perform or provide access to a functionality related to the recommendation 335. Selecting a learn action button 337 can provide access to related content of the recommendation 335. In the example of FIG. 3B, selecting the commit action button 336 can provide access to a feature for adding a tag for a page to a video post. Selecting the learn button 337 will show an administrator how to add a tag for a page to a video post.

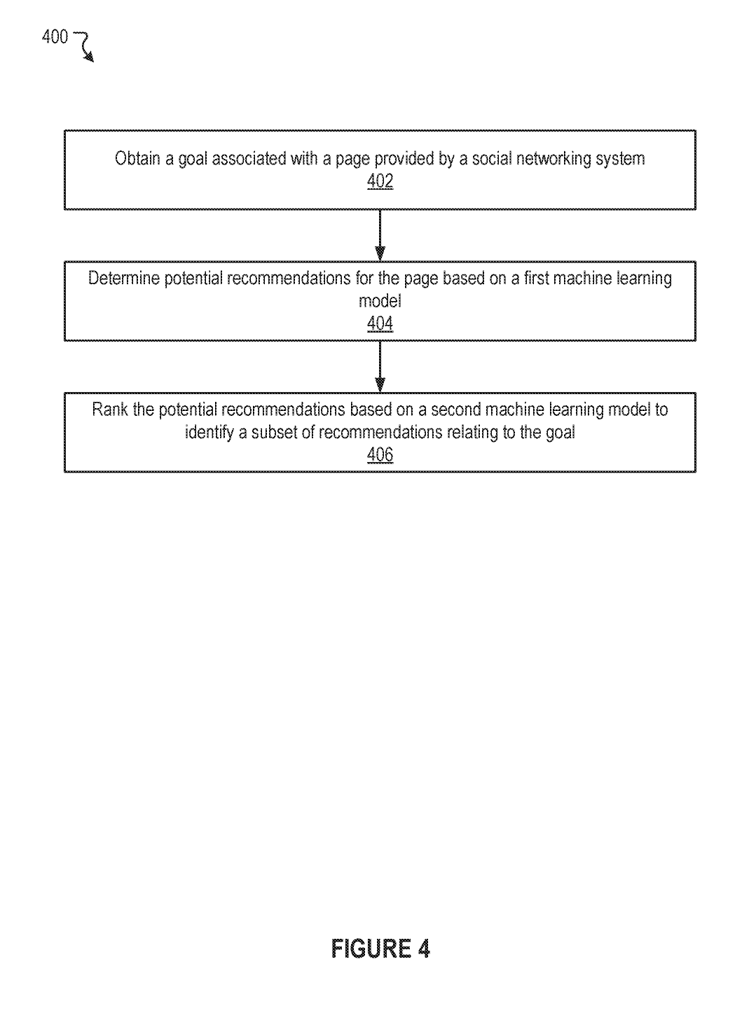

FIG. 4 illustrates an example first method 400 for determining recommendations for pages, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain a goal associated with a page provided by a social networking system. At block 404, the example method 400 can determine potential recommendations for the page based on a first machine learning model. At block 406, the example method 400 can rank the potential recommendations based on a second machine learning model to identify a subset of recommendations relating to the goal. Other suitable techniques that incorporate various features and embodiments of the present technology are possible.

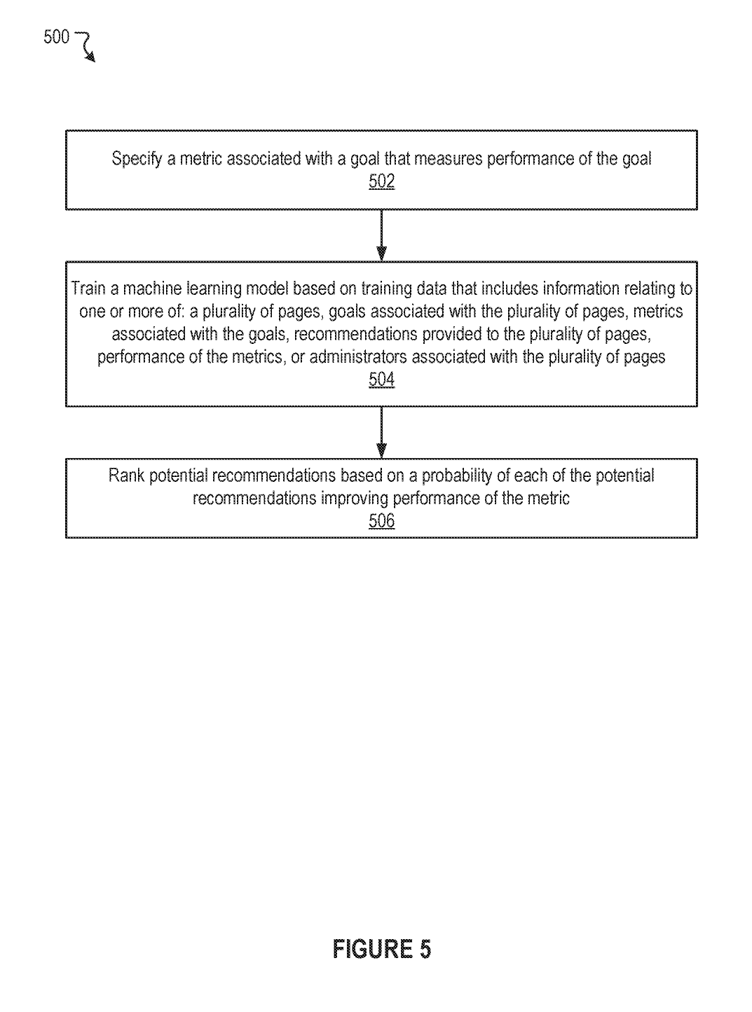

FIG. 5 illustrates an example second method 500 for determining recommendations for pages, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can specify a metric associated with a goal that measures performance of the goal. The goal can be similar to the goal associated with the page explained in connection with FIG. 4. At block 504, the example method 500 can train a machine learning model based on training data that includes information relating to one or more of: a plurality of pages, goals associated with the plurality of pages, metrics associated with the goals, recommendations provided to the plurality of pages, performance of the metrics, or administrators associated with the plurality of pages. The machine learning model can be similar to the first machine learning model or the second machine learning model explained in connection with FIG. 4. At block 506, the example method 500 can rank potential recommendations based on a probability of each of the potential recommendations improving performance of the metric. The potential recommendations can be similar to the potential recommendations explained in connection with FIG. 4. Other suitable techniques that incorporate various features and embodiments of the present technology are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a recommendation determination module 646. The recommendation determination module 646 can, for example, be implemented as the recommendation determination module 102, as discussed in more detail herein. As discussed previously, it should be appreciated that there can be many variations or other possibilities. For example, in some embodiments, one or more functionalities of the recommendation determination module 646 can be implemented in the user device 610.

### Hardware Implementation

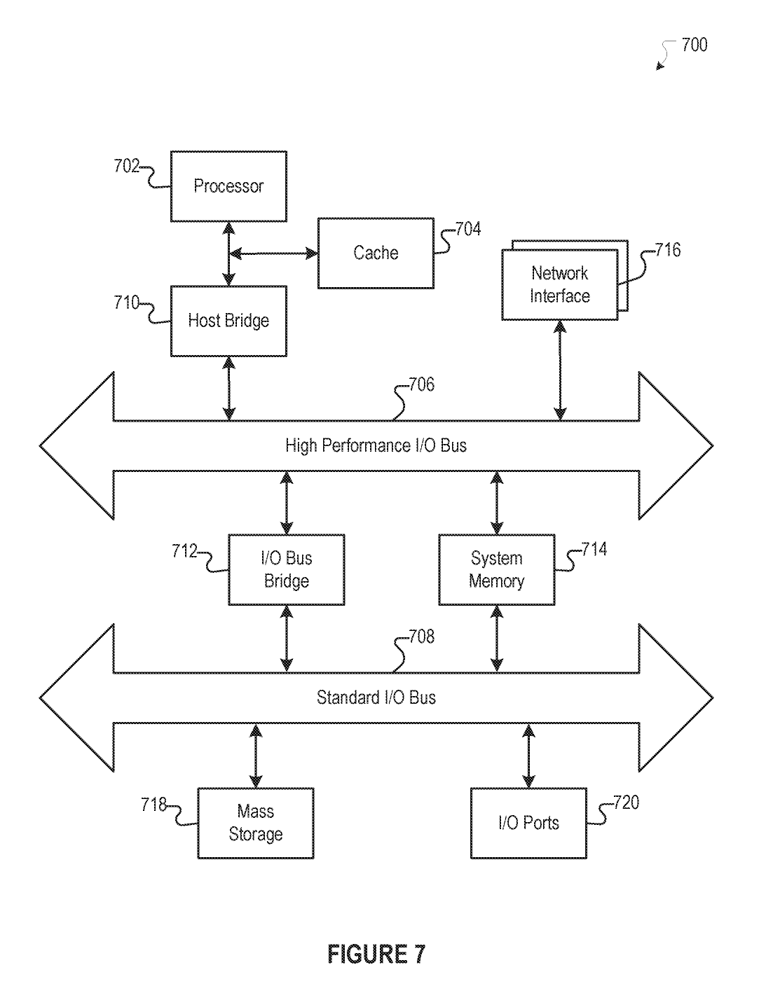

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a goal associated with a page provided by a social networking system;
determining, by the computing system, potential recommendations for the page based on a first machine learning model; and
ranking, by the computing system, the potential recommendations based on a second machine learning model to identify a subset of recommendations relating to the goal.

2. The computer-implemented method of claim 1, further comprising providing one or more recommendations of the identified subset of recommendations for display in a user interface associated with the page.

3. The computer-implemented method of claim 2, further comprising providing access to a content item relating to a recommendation of the one or more recommendations in the user interface associated with the page, wherein the content item relating to the recommendation provides instructions associated with performing the recommendation.

4. The computer-implemented method of claim 1, wherein the goal is associated with a metric that measures performance of the goal.

5. The computer-implemented method of claim 4, wherein the ranking the potential recommendations is based on a probability of each of the potential recommendations improving performance of the metric.

6. The computer-implemented method of claim 1, further comprising training the first machine learning model based on training data that includes information relating to a plurality of pages and recommendations provided to the plurality of pages.

7. The computer-implemented method of claim 1, further comprising training the second machine learning model based on training data that includes information relating to one or more of: a plurality of pages, goals associated with the plurality of pages, metrics associated with the goals, recommendations provided to the plurality of pages, performance of the metrics, or administrators associated with the plurality of pages.

8. The computer-implemented method of claim 1, wherein the first machine learning model and the second machine learning are the same.

9. The computer-implemented method of claim 1, wherein a first recommendation and a second recommendation in the identified subset of recommendations are related, and the method further comprises providing the first recommendation and the second recommendation in a sequential order in time.

10. The computer-implemented method of claim 1, wherein the ranking the potential recommendations comprises determining whether the potential recommendations satisfy eligibility criteria associated with the page.

11. A system comprising:
at least one hardware processor; and
a memory storing instructions that, when executed by the at least one processor, cause the system to perform:
obtaining a goal associated with a page provided by a social networking system;
determining potential recommendations for the page based on a first machine learning model; and
ranking the potential recommendations based on a second machine learning model to identify a subset of recommendations relating to the goal.

12. The system of claim 11, wherein the instructions further cause the computing system to perform providing one or more recommendations of the identified subset of recommendations for display in a user interface associated with the page.

13. The system of claim 11, wherein the goal is associated with a metric that measures performance of the goal, and wherein the ranking the potential recommendations is based on a probability of each of the potential recommendations improving performance of the metric.

14. The system of claim 11, wherein the instructions further cause the computing system to perform training the first machine learning model based on training data that includes information relating to a plurality of pages and recommendations provided to the plurality of pages.

15. The system of claim 11, wherein the instructions further cause the computing system to perform training the second machine learning model based on training data that includes information relating to one or more of: a plurality of pages, goals associated with the plurality of pages, metrics associated with the goals, recommendations provided to the plurality of pages, performance of the metrics, or administrators associated with the plurality of pages.

16. A non-transitory computer readable medium including instructions that, when executed by at least one hardware processor of a computing system, cause the computing system to perform a method comprising:
obtaining a goal associated with a page provided by a social networking system;
determining potential recommendations for the page based on a first machine learning model; and
ranking the potential recommendations based on a second machine learning model to identify a subset of recommendations relating to the goal.

17. The non-transitory computer readable medium of claim 16, wherein the method further comprises providing one or more recommendations of the identified subset of recommendations for display in a user interface associated with the page.

18. The non-transitory computer readable medium of claim 16, wherein the goal is associated with a metric that measures performance of the goal, and wherein the ranking the potential recommendations is based on a probability of each of the potential recommendations improving performance of the metric.

19. The non-transitory computer readable medium of claim 16, wherein the method further comprises training the first machine learning model based on training data that includes information relating to a plurality of pages and recommendations provided to the plurality of pages.

20. The non-transitory computer readable medium of claim 16, wherein the method further comprises training the second machine learning model based on training data that includes information relating to one or more of: a plurality of pages, goals associated with the plurality of pages, metrics associated with the goals, recommendations provided to the plurality of pages, performance of the metrics, or administrators associated with the plurality of pages.
